(19) United States
(12) Patent Application Publication
(10) Pub. No.: US 2008/0166519 A1
(43) Pub. Date: Jul. 10, 2008

(54) INTELLIGENT BI-STABLE STRUCTURE SYSTEM

(76) Inventor: Eugene H. C. LEUNG, London (GB)

Correspondence Address: LEONG C LEI, PMB # 1008, 1867 YGNACIO VALLEY ROAD, WALNUT CREEK, CA, 94598, US

(21) Appl. No.: 11/621,564

(22) Filed: Jan. 10, 2007

(51) Int. Cl. B32B 7/04

(52) U.S. Cl. 428/120

(57) ABSTRACT

The present invention discloses intelligent bi-stable structure system is provided. The system has a discrete number of states. The system comprises a plurality of bi-stable metal strips, a plurality of connections connecting the bi-stable metal strips, and at least one control point for controlling the state of the system. The connections are provided to have the system being in one stable state and the system transforms from one stable state to another stable state as the control point is activated. Since the system absorbs energy in order to transform from one state to a second state by activating a control point, the system can be utilized in dampers, walls for sustaining earthquake. Furthermore, the system can divide the space into various configurations according to the various states of the system so as to provide flexible spatial utilization and flexible landscape.

### BACKGROUND OF THE INVENTION

(a) Technical Field of the Invention

The present invention is generally related to an intelligent bi-stable structure system and more particularly to an intelligent bi-stable structure system by utilizing a bi-stable metal.

(b) Description of the Prior Art

Bi-stable metal is a type of string steel and has the capability to be straight and then curl up. The string steel has two stable states and hence is referred to as a bi-stable metal. The application of the bi-stable metal can be found popularly in toys like “slap bracelets”.

For example, another application of the bi-stable metal is a toy band which comprises a bi-stable metal spring that can be dynamically deployed from an elongated rigid position to a coiled position around one's wrist, forearm, other part of the body, or any suitably-shaped object through striking the band against that part of the body or object.

The devices made from bi-stable metal have the following characteristics. The devices comprised of several bi-stable metal strips will collapse from a flat or straight position into a spatial configuration. The devices transform from an initial state or 2D surface into a second state or 3D space. These bi-stable metal strips are attached in various ways to create various shapes. The metal strips are embedded with a performance operation capable of curling up into a cylinder or withholding potential energy when straight. The sectional convex curve allows the metal to remain straight and only when the sectional curve is deformed the object strip becomes unstable and curls up into the second stable state. The combination of strips allows one to dictate a sequential transformation and hence control its final stable state. Therefore, these bi-stable devices transform from one stable state (initial planar condition) to a second stable state (spatial condition) through a series of sequential activation points.

The method for fabricating bi-stable metal, for example, is described in an article by E. Kebadze, S. D. Guest, and S. Pellegrino on the topic of bi-stable material including material potential and fabrication process (International Journal of Solids and structure 41 (2004) pp. 2801-2820). The utilization of the above mentioned characteristics of the bi-stable devices initiates a new era for various fields. For instance, other than toys, the bi-stable device can be used as a damper, a wall for sustaining earthquake, a flexible architecture space, and so forth.

Therefore, a new intelligent bi-stable structure system comprised of bi-stable metal is provided for using in the various fields to meet industrial requirements.

### SUMMARY OF THE INVENTION

The primary purpose of the present invention is to provide a new intelligent bi-stable structure system. The system has a discrete number of states. Since the system absorbs energy in order to transform from one state to a second state by activating a control point, the system can be utilized in dampers, walls for sustaining earthquake. Furthermore, the system can divide the space into various configurations according to the various states of the system so as to provide flexible spatial utilization and flexible landscape.

One object of the present invention is to provide an intelligent bi-stable structure system. The system has a first stable state and a second stable state and comprises a first bi-stable layer, a second bi-stable layer, and at least one connection connecting the first bi-stable layer and the second bi-stable layer. The system further comprises at least one control point designed to be positioned along the length of the bi-stable layers for controlling the state of the system. While the control point is activated, the system transforms from the first stable state to the second stable state.

Another object of the present invention is to provide an intelligent bi-stable structure system. The system has a discrete number of stable states. The system comprises at least two bi-stable layers and at least two connections connecting the at least two bi-stable layers. The system further comprises at least one control point designed to be positioned along the length of the bi-stable layers for controlling the state of the system. The bi-stable layers can be all formed by bi-stable metal strips.

Another object of the present invention is to provide an intelligent structure system. The system comprises a plurality of bi-stable metal strips, a plurality of connections connecting the bi-stable metal strips, and at least one control point for controlling the state of the system. The connections are provided to have the system being in one stable state and the system transforms from one stable state to another stable state as the control point is activated.

Accordingly, the present invention discloses an intelligent bi-stable structure system capable of switching between a discrete number of states by activating control points so as to provide various applications, such as dampers, flexible robotic arm, rail system, cushions, flexible spatial utilization, and flexible landscape.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 shows the A formation model for a bi-stable single layer comprised of bi-stable metal strips;

FIGS. 2A˜2C show the B formation models having (A) “T” shape, (B) cross shape, and (C) “L” shape for a bi-stable single layer comprised of bi-stable metal strips;

FIGS. 3A˜3C show the C formation models having (A) “T” shape, (B) cross shape, and (C) “L” shape for a bi-stable single layer comprised of bi-stable metal strips;

FIGS. 4A˜4E show the D formation models having various Z shapes for a bi-stable single layer comprised of bi-stable metal strips;

FIG. 5 shows the E formation model having various angles between two stripes for a bi-stable single layer comprised of bi-stable metal strips;

FIGS. 6A˜6D show the F formation models having various tri series for a bi-stable single layer comprised of bi-stable metal strips;

FIG. 7 shows an example of the system comprised of two bi-stable layers transforming from one state to the other state according to the first embodiment of the present invention;

FIG. 8 shows an example of the system transforming from one state to the other state according to the first embodiment of the present invention;

FIG. 9 shows an example of the system transforming from one state to the other state according to the first embodiment of the present invention;

FIG. 10 shows an example of the system transforming from one state to the other state according to the first embodiment of the present invention;

FIG. 11 shows an example of the system comprised of three bi-stable layers transforming from one state to the other state according to the second embodiment of the present invention;

FIG. 12 shows an example of the rail system transforming from one state to the other state according to the third embodiment of the present invention;

FIG. 13 shows an example of the network system transforming from one state to the other state according to the third embodiment of the present invention;

FIG. 14 shows an example of the skinned zig-zag system transforming from one state to the other state according to the third embodiment of the present invention.

FIG. 15 shows an example of the linear muti-peel system transforming from one state to the other state according to the third embodiment of the present invention; and

FIG. 16 shows an example of the cross muti-peel system transforming from one state to the other state according to the third embodiment of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

What is probed into the invention is an intelligent bi-stable structure system. Detail descriptions of the structure and elements will be provided in the following in order to make the invention thoroughly understood. Obviously, the application of the invention is not confined to specific details familiar to those who are skilled in the art. On the other hand, the common structures and elements that are known to everyone are not described in details to avoid unnecessary limits of the invention. Some preferred embodiments of the present invention will now be described in greater detail in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

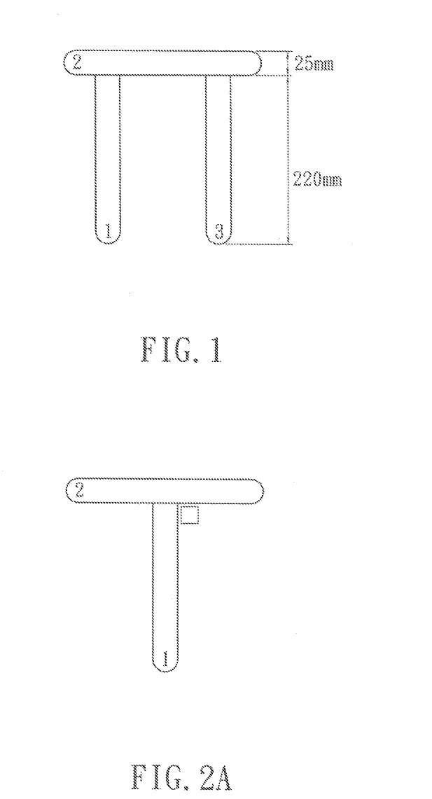

As shown in FIGS. 1A˜6D, in general, a bi-stable single layer comprised of bi-stable metal strips can be modeled as A˜F formations to have various characteristics.

As shown in FIG. 1, the ‘A’ series formations were created from an initial planar condition in the shape of a horse shoe. The final form resulted from a sequential collapse of one stable state (planar condition) to a second stable state (spatial condition). This ‘U’ shaped configuration comprise of 3 metal strips connected by 90 degree rigid connections. Cross sections are unidirectional. Characteristics include symmetrical shape, behavior and performance.

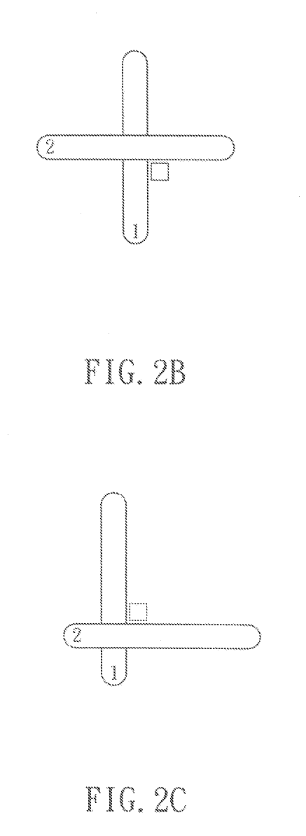

As shown in FIGS. 2A˜2C, creation of the ‘B’ formations was developed from various shapes including (A)‘T’ shape (B) Cross shape (C) ‘L’ shape. Sequential collapses were performed in a consistent manner to compare outcomes based solely on shape. Similar to the ‘A’ Formations, the composition of the 2D (perceived) initial condition is made up of 90 degree connection, but with 2 metal strips. Cross sections are unidirectional. Characteristics include symmetrical shape, behavior and performance.

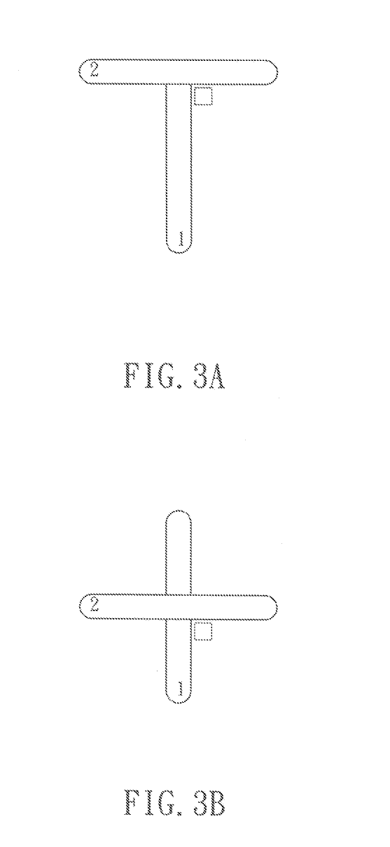

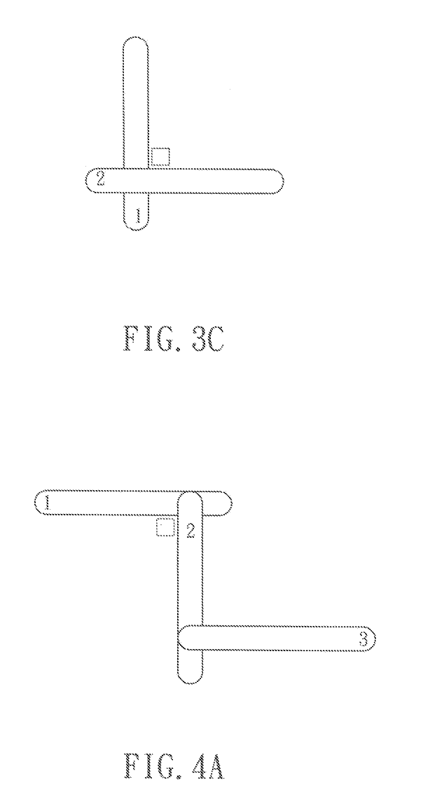

As shown in FIGS. 3A˜3C, the creation of the ‘C’ formations including (A)‘T’ shape (B) Cross shape (C) ‘L’ shape is near identical to the ‘B’ Series with the exception of the unidirectional cross section. This series comprises of 2 metal strips with one inverted face. As a result, the performance or collapse of the initial condition creates a separation effect allowing a comparison based solely on directionality. The opposing cross section creates nonsymmetrical behavior and performance while the initial overall shape remains symmetrical.

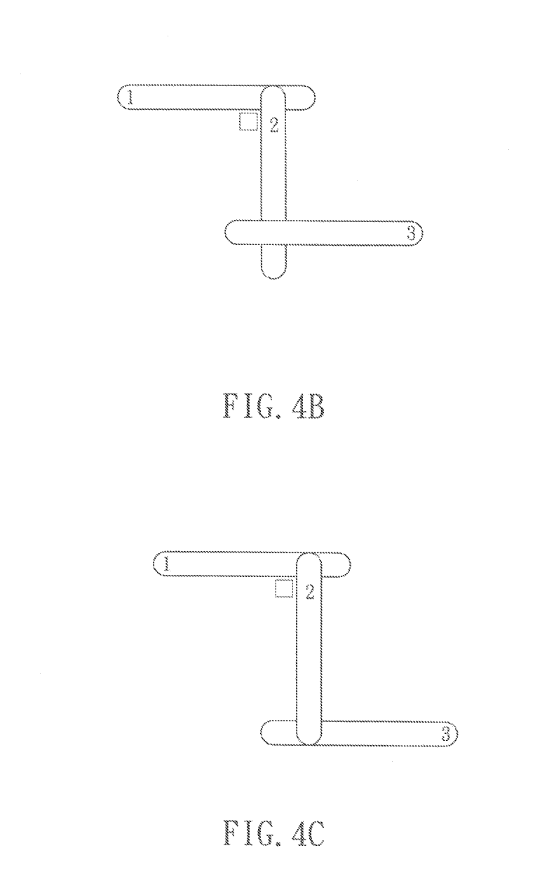

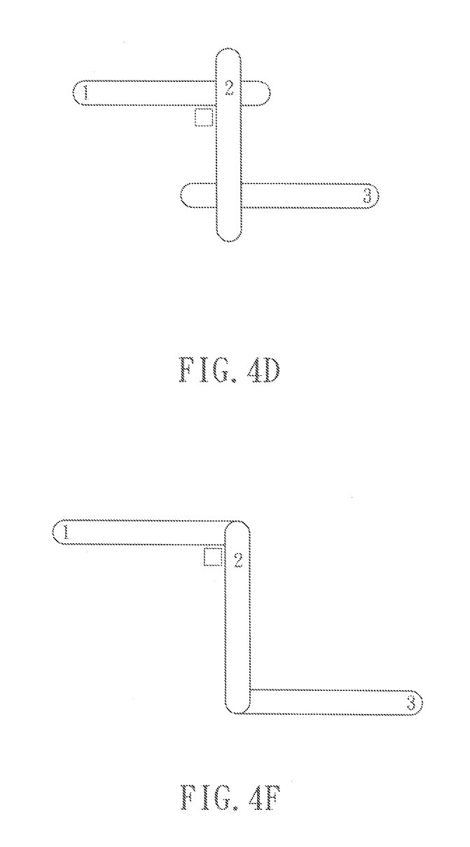

As shown in FIGS. 4A˜4E, the ‘D’ formation (“Z” series) comprises of 3 metal strips connected at 90 degrees composed in a shape similar to a ‘Z’. The semi-symmetrical shape exhibits symmetrical performance and behavior. This set also contains extra versions labeled: Da, Db, Dc, and Dd. This allows for comparison between the slight variations and a means for evaluating of any significant outcomes based on the amplification effect of the initial condition. All cross sections are unidirectional.

As shown in FIG. 5, the ‘E’ formations (angled series) use multiple angles of connection including 90, 60, 30, 10 degrees. The outcomes allow for a comparison based solely on angled connections. In addition, the planar condition takes on a shape similar to a ‘T’ with a resulting outcome that can be compared to the ‘B’ Series. Shape, behavior and performance are nonsymmetrical and cross sections are unidirectional. Initial condition has a slight degree of instability.

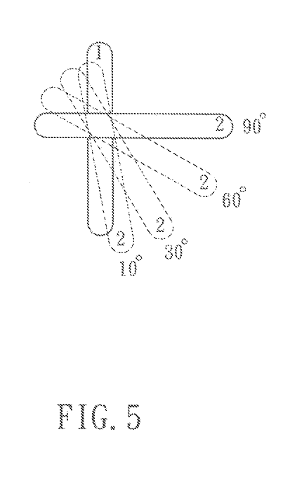

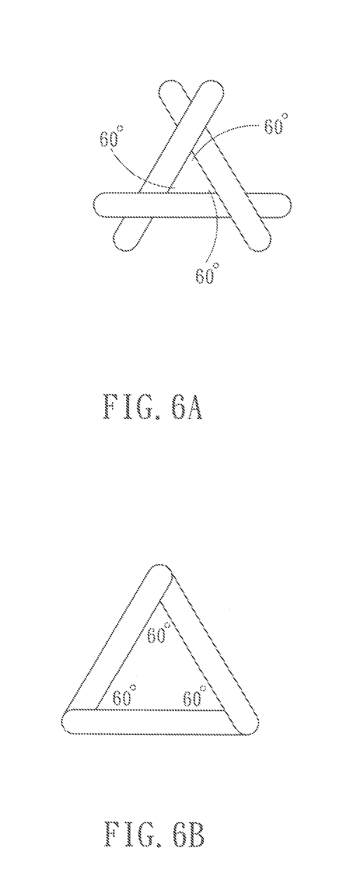

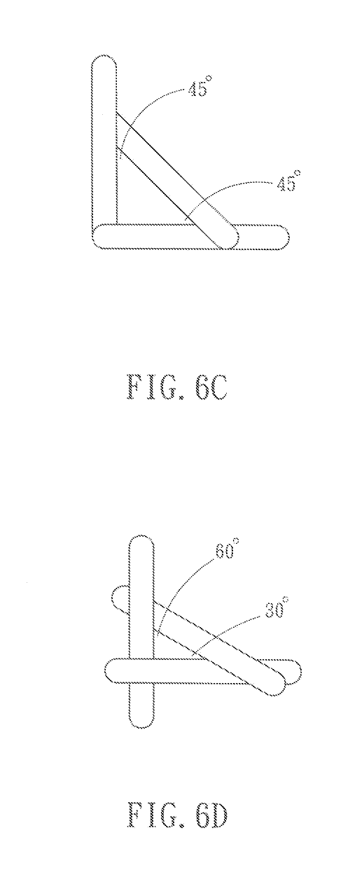

As shown in FIGS. 6A˜6D, the ‘F’ formation (tri series) is unlike previous groupings due to its initial condition forming a closed loop. The former series allow for free ends, meaning strips are not attached at one end. As a result, the performance is significantly different in 2 ways. The first is that a sequential collapse is impossible. The second difference is that the performance is created through multiple strips forcing it to twist, generating curves and knots. The ‘F’ formation comprise of 3 strips with an approximate shape of an ‘A’ and with multiple angled connections. This type of arrangement is nearly unstable in the planar condition. Cross sections are unidirectional. Characteristics include symmetrical shape, behavior and performance.

In addition to the initial configuration setup, the decision to activate or collapse certain points and strips leads to one specific outcome. The results may vary slightly from outcome to outcome, but the general formation remains consistent. The design of the device contains elements that influence the end result. For example, the nuts/bolts interfere with the sequence and play a secondary role as spacers. They may also redirect the flow of motion. The connections located near the edge create a factor of instability and reducing the level of control. In the case of simultaneous collapse (activation of all strips at once) results in unique and unpredictable formations. Knots and twists may form. The material used is known as bi-stable metal. The metal is a type of spring steel or more specific a type of tape spring steel or carbon spring steel. The metal has the capacity to be in two stable states: curl and straight. In the straight position, the metal contains potential energy and is only released when the cross sectional curve is deformed. While in the unstable state, the metal will roll up in a linear fashion only to stop when blocked or until the metal curls up completely.

There are critical factors to affect the outcome including: velocity (dictated by the strength of metal), length and thickness of metal (dictates strength of metal), time (the period between collapse initiation), shape of cross section, location of collapse and connections, angle of connection, type of connection, defects within metal or connection, tightness of connection, cross sectional facing up or down, interferes (with itself, another metal strip or with surfaces), sequence of collapse, overall shape or configuration of metal (including symmetry, directionality, angle of connection), and the layering order to mention a few.

Based on the above-mentioned characteristics of the bi-stable metal material, the present invention provides an intelligent bi-stable structure system with bi-stable metal strips. The metal used is made of various combinations of elements (beryllium-copper) and incorporates a curved cross-section. When the cross section is deformed, the metal strip will destabilize and curl up, referred to as a collapse. The metal retains residual stresses giving the material the property to curling up. The cross sectional curve allows the metal to remain straight. The combination gives the metal its bi-stable characteristics.

In a first embodiment of the present invention, an intelligent bi-stable structure system is provided. The system has a first stable state and a second stable state and comprises a first bi-stable layer, a second bi-stable layer, and at least one connection connecting the first bi-stable layer and the second bi-stable layer. The system further comprises at least one control point designed to be positioned along the length of the bi-stable layers for controlling the state of the system. While the control point is activated, the system transforms from the first stable state to the second stable state. The first stable state is straight or planar and the second stable state is curled up or collapsed. The structure of the system in the first stable state is different from that in the second stable state.

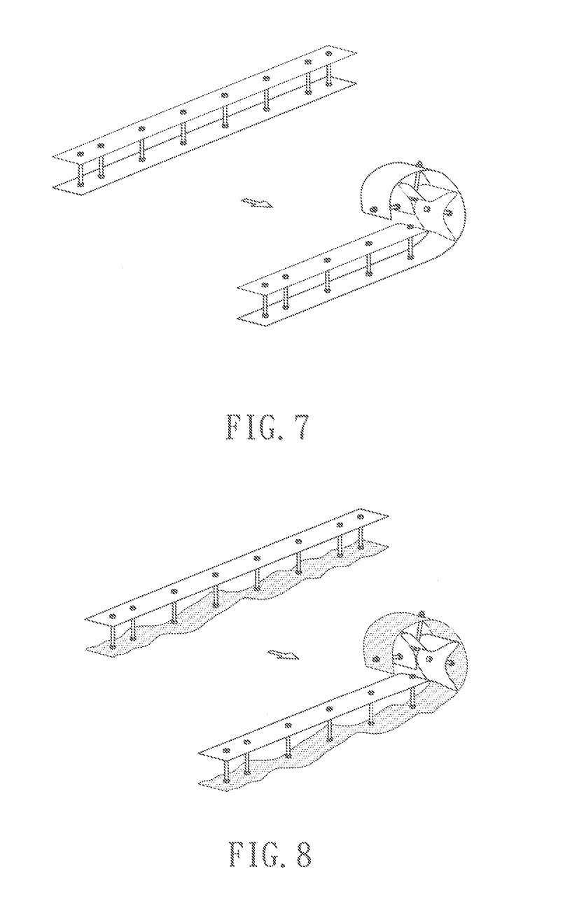

FIG. 7 shows an example of the system comprised of two bi-stable layers transforming from one state to the other state. As shown in FIG. 7, the first bi-stable layer and the second bi-stable layer are both formed by bi-stable metal strips. In another example, the first bi-stable layer is formed by a bi-stable metal strip and the second bi-stable layer is formed by the material other than the bi-stable metal, as shown in FIG. 8. The first bi-stable layer and the second bi-stable layer are provided such that the second bi-stable layer is on the outside while the system transforms from the first stable state to the second stable state. That is, while the system curls up, the second bi-stable layer is on the outside.

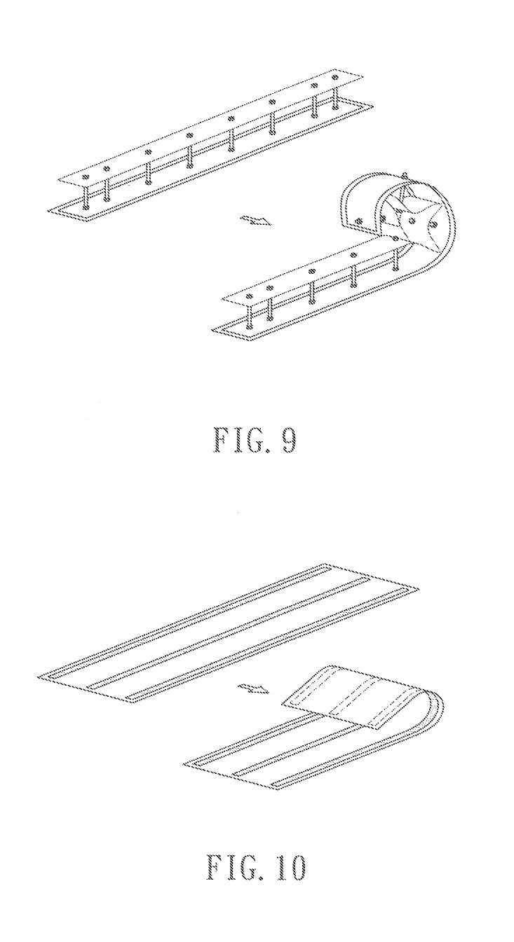

In an example, either the first bi-stable layer or the second bi-stable layer has an attached skin surface, as shown in FIG. 9. The skin surface can be an elastic skin or a metal mesh. The elastic skin provides the system to stretch and retract. As shown in FIG. 9, the surface skin is attached on the lower bi-stable layer which is on the outside while curling up.

In an example, the connection comprises nuts and bolts so that the first bi-stable layer and the second bi-stable layer are stacked and separated with a distance determined by the nuts and bolts. The bolts used to attach the metal strips prevent the system from becoming completely unstable and isolate the movement between the bolts. The allocation of bolts and nuts and the length of the bolt affect the curling-up state of the system.

In an example, as shown in FIG. 10, the system further comprises a skin surface. The skin surface and the connections are provided so that the first bi-stable layer and the second bi-stable layer are attached in parallel on the skin surface. The configuration extends the width of the system. The radius of the second stable state of the system can be adjusted by the skin surface and the connections. The skin surface can be soft, such as a plastic film or rubber band. Or, the skin surface can be a rigid skin made from wood or nuts/bolts. The state of the system can be further controlled by either soft or rigid skin together with the connections.

When the control point is activated, the space divided by the system in the first stable state transforms to the space divided by the system. The system can be used as a flexible spatial partition or divider.

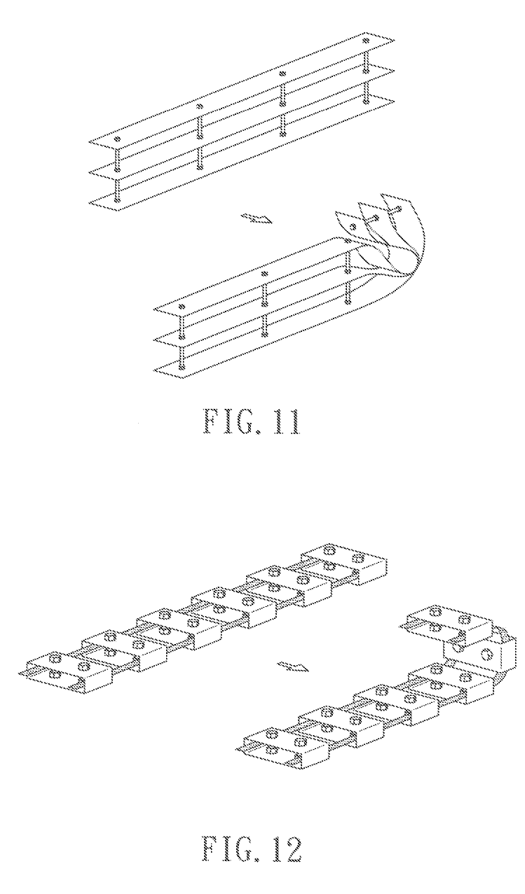

In a second embodiment of the present invention, an intelligent bi-stable structure system is provided. The system has a discrete number of stable states. The system comprises a plurality of bi-stable layers and at least two connections connecting the bi-stable layers. In an example shown in FIG. 11, the system comprises three bi-stable layers and four connections connecting the three bi-stable layers. The system comprises at least one control point designed to be positioned along the length of the bi-stable layers for controlling the state of the system. The bi-stable layers are all formed by bi-stable metal strips.

In another example of the embodiment, some of the bi-stable layers are formed by bi-stable metal strips and the rest of the bi-stable layers are formed by the material other than the bi-stable metal. The material other than the bi-stable metal can be a plastic film, wood, or a metal mesh.

In an example, some of the bi-stable layers or all have attached skin surfaces. The skin surface can be an elastic skin or rigid skin. The skin surface can be made from a metal mesh or a plastic film.

In one example, the connection can be nuts and bolts provided so that the bi-stable layers are stacked and separated with distances determined by the nuts and bolts. In one other example, the system further comprises a skin surface. The skin surface and the connection are provided so that bi-stable layers are attached in parallel on the skin surface.

In one example, the system comprises control points designed to be positioned crossing the length of the bi-stable layers for controlling the state of the system. Thus, the system now has a twist stable state and a planar stable state.

The space divided by the system transforms to the space divided by the system in one other stable state while the control points are activated sequentially.

In a third embodiment of the present invention, an intelligent structure system is provided. The system comprises a plurality of bi-stable metal strips, a plurality of connections connecting the bi-stable metal strips, and at least one control point for controlling the state of the system. The connections are provided to have the system in one stable state and the system transforms from one stable state to another stable state as the control point is activated.

In a preferred example, the bi-stable metal strips are provided to form a rail system and the connections are sleeves provided on the rail system, as shown in FIGS. 12. The sleeves control and organize the metal strips.

In an example of this embodiment, the metal strips can be stacked along its ends elongating the strip to any desirable length. Unlike other linear connections, the stacking creates a more articulate collapse expressing each strip as individual but yet connected to the overall whole.

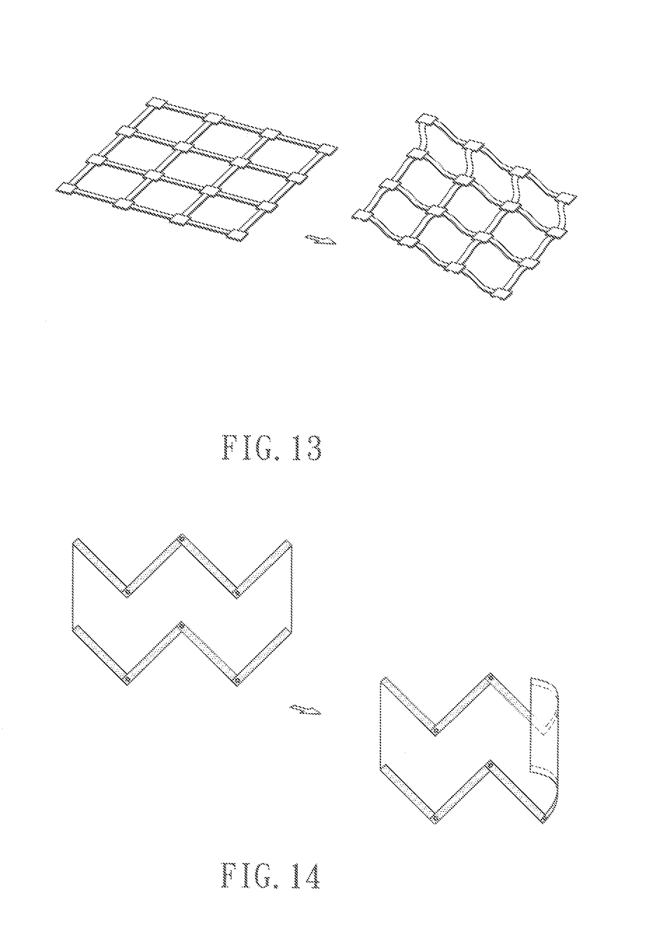

In an example of this embodiment, the bi-stable metal strips are provided to form a network system and the connections are non-rigid attachments for allowing the strips to rotate and adjust to neighboring strips, as shown in FIG. 13.

In an example of this embodiment, the bi-stable metal strips are provided to form a zig-zag system and the connections are a skin surface for allowing the strips to have unidirectional snapping, as shown in FIG. 14.

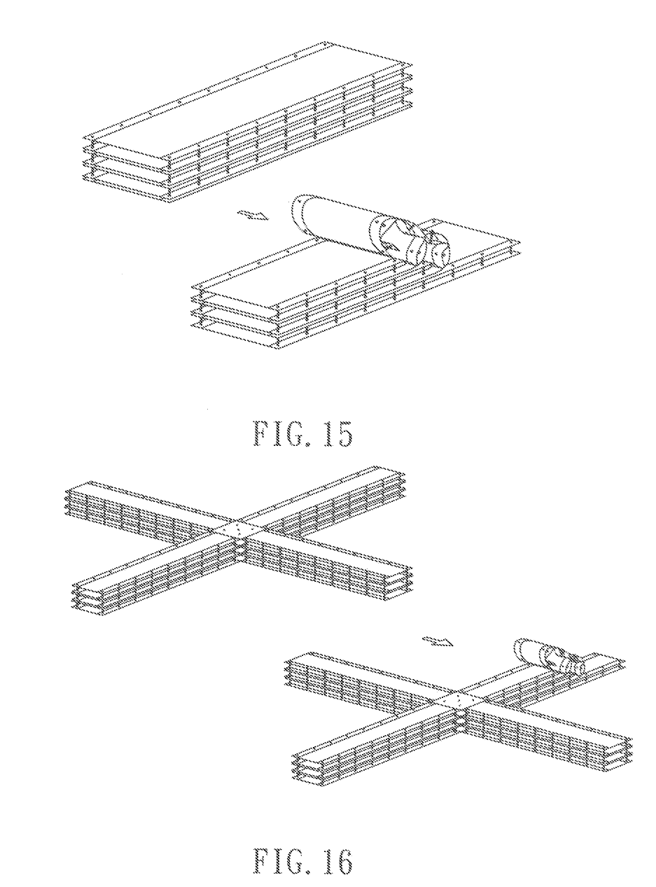

In this embodiment, the system further comprises a plurality of skin surfaces, each attached to at least one of the bi-stable metal strips. The skin surfaces are provided to form a multiple-layered system connected by the connections for allowing the system to have multi-peeling states depending on which control point is activated. One example is shown in FIG. 15. It shows a prototype for dampers, or walls capable of earthquake-proof. FIG. 15 shows a linear multi-peel system. In another example, the system can be a cross multi-peel system, as shown in FIG. 16.

To sum up, the present invention discloses an intelligent bi-stable structure system capable of switching between a discrete number of states by activating control points so as to provide various applications, such as dampers, flexible robotic arm, rail system, cushions, flexible spatial utilization, and flexible landscape.

Obviously many modifications and variations are possible in light of the above teachings. For example, the skin surface may have waved edge. In the collapse state, the edge becomes weaved into the adjacent spaces and hence diminished the sense of the boundary. The material other than bi-stable metal includes silicone, foam, and so forth, besides the plastic film or metal mesh. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An intelligent bi-stable structure system, having a first stable state and a second stable state, the system comprising:
a first bi-stable layer;
a second bi-stable layer; and
at least one connection connecting the first bi-stable layer and the second bi-stable layer.

2. The system according to claim 1, further comprising:
at least one control point designed to be positioned along the length of the bi-stable layers for controlling the state of the system.

3. The system according to claim 1, wherein the first bi-stable layer and the second bi-stable layer are both formed by bi-stable metal strips.

4. The system according to claim 2, wherein the first bi-stable layer and the second bi-stable layer are both formed by bi-stable metal strips.

5. The system according to claim 1, wherein the first bi-stable layer is formed by a bi-stable metal strip and the second bi-stable layer is formed by the material other than the bi-stable metal.

6. The system according to claim 2, wherein the first bi-stable layer is formed by a bi-stable metal strip and the second bi-stable layer is formed by the material other than the bi-stable metal.

7. The system according to claim 6, wherein the first bi-stable layer and the second bi-stable layer are provided such that the second bi-stable layer is on the outside while the system transforms from the first stable state to the second stable state.

8. The system according to claim 1, wherein either the first bi-stable layer or the second bi-stable layer has an attached skin surface.

9. The system according to claim 2, wherein either the first bi-stable layer or the second bi-stable layer has an attached skin surface.

10. The system according to claim 8, wherein the skin surface is an elastic skin.

11. The system according to claim 9, wherein the skin surface is an elastic skin.

12. The system according to claim 9, wherein the skin surface is a metal mesh.

13. The system according to claim 1, wherein the connection comprises nuts and bolts so that the first bi-stable layer and the second bi-stable layer are stacked and separated with a distance determined by the nuts and bolts.

14. The system according to claim 1, further comprising a skin surface wherein the connection and the skin surface are provided so that the first bi-stable layer and the second bi-stable layer are attached in parallel on the skin surface.

15. The system according to claim 14, wherein the skin surface is a plastic film.

16. The system according to claim 14, wherein the skin surface is made from wood or nuts/bolts.

17. The system according to claim 1, wherein the first stable state is straight or planar and the second stable state is curled up or collapsed.

18. The system according to claim 2, wherein the structure divided of the system in the first stable state transforms to the structure of the system as the at least one control point is activated.

19. The system according to claim 2, wherein the space divided by the system in the first stable state transforms to the space divided by the system as the at least one control point is activated.

20. An intelligent bi-stable structure system, having a discrete number of stable states, the system comprising:
at least two bi-stable layers; and
at least two connections connecting the at least two bi-stable layers.

21. The system according to claim 20, further comprising:
at least one control point designed to be positioned along the length of the bi-stable layers for controlling the state of the system.

23. The system according to claim 20, wherein the bi-stable layers are all formed by bi-stable metal strips.

24. The system according to claim 21, wherein the bi-stable layers are all formed by bi-stable metal strips.

25. The system according to claim 20, wherein some of the bi-stable layers are formed by bi-stable metal strips and the rest of the bi-stable layers are formed by the material other than the bi-stable metal.

26. The system according to claim 21, wherein some of the bi-stable layers are formed by bi-stable metal strips and the rest of the bi-stable layers are formed by the material other than the bi-stable metal.

27. The system according to claim 20, wherein some of the bi-stable layers have attached skin surfaces.

28. The system according to claim 21, wherein some of the bi-stable layers have attached skin surfaces.

29. The system according to claim 27, wherein the skin surface is an elastic skin.

30. The system according to claim 28, wherein the skin surface is an elastic skin.

31. The system according to claim 27, wherein the skin surface is a metal mesh.

32. The system according to claim 28, wherein the skin surface is a metal mesh.

33. The system according to claim 20, wherein the connection comprises nuts and bolts so that the bi-stable layers are stacked and separated with distances determined by the nuts and bolts.

34. The system according to claim 20, further comprising a skin surface wherein the skin surface and the connection are provided so that the bi-stable layers are attached in parallel on the skin surface.

35. The system according to claim 34, further comprising:
at least one control point designed to be positioned crossing the length of the bi-stable layers for controlling the state of the system;
wherein the control points makes the system have a twist stable state and a planar stable state.

36. The system according to claim 20, wherein one stable state is straight or planar and a second stable state is curled up or collapsed.

37. An intelligent structure system, the system comprising:
a plurality of bi-stable metal strips;
a plurality of connections connecting the bi-stable metal strips; and,
at least one control point for controlling the state of the system;
wherein the connections are provided to have the system being in one stable state and the system transforms from one stable state to another stable state as the control point is activated.

38. The system according to claim 37, wherein the bi-stable metal strips are provided to form a rail system and the connections are sleeves provided on the rail system.

39. The system according to claim 37, wherein the bi-stable metal strips are provided to form a network system and the connections are non-rigid attachments for allowing the strips to rotate and adjust to neighboring strips.

40. The system according to claim 37, wherein the bi-stable metal strips are provided to form a zig-zag system and the connections are a skin surface for allowing the strips to have unidirectional snapping.

41. The system according to claim 37, further comprising:
a plurality of skin surfaces, each attached to at least one of the bi-stable metal strips;
wherein the skin surfaces are provided to form a multiple-layered system connected by the connections for allowing the system to have multi-peeling states depending on which control point is activated.

42. The system according to claim 41, wherein the skin surface is an elastic skin.

43. The system according to claim 41, wherein the skin surface is a metal mesh.

44. The system according to claim 37, wherein the space divided by the system in one stable state transforms to the space divided by the system in another stable while the at least one control point is activated.

45. The system according to claim 37, wherein the connections comprise nuts and bolts.
